(19) United States
(12) Patent Application Publication
(10) Pub. No.: US 2021/0081606 A1
(43) Pub. Date: Mar. 18, 2021

(54) DATA MODEL FOR PAGE LAYOUTS

(71) Applicant: Microsoft Technology Licensing, LLC, Redmond, WA (US)

(72) Inventors: Michael J. WILLARD, Snohomish, WA (US); Murali Krishnan ELANGOVAN, Kirkland, WA (US); Neil B. OWEN, Bothell, WA (US); Uma M. NELLURI, Woodinville, WA (US); Allen L. WAGNER, Kirkland, WA (US)

(21) Appl. No.: 16/837,989

(22) Filed: Apr. 1, 2020

Related U.S. Application Data
(60) Provisional application No. 62/902,370, filed on Sep. 18, 2019.

(51) Int. Cl. G06F 40/186; G06F 16/958; G06F 40/14; G06F 3/0484; G06F 3/0482

(52) U.S. Cl. CPC G06F 40/186; G06F 16/986; G06F 3/0482; G06F 3/0484; G06F 40/14

(57) ABSTRACT

Systems and methods receive a user input requesting access to a template and display the template having a layout defined by a set of rules. User inputs corresponding to the template are also received at a graphical user interface, the user inputs changing content in the template, wherein allowable modifications to the template are defined by a master template using the data model. The template is generated from the master template. A plurality of webpages defined by the template with the allowable modifications are dynamically built, wherein a URL is associated separately from the plurality of webpages, with the URL tracked as a separate entity, that allows for more efficient generation of different content.

### CROSS-REFERENCE TO RELATED APPLICATION

This nonprovisional application claims the benefit of and priority to U.S. Provisional Application No. 62/902,370, entitled “Data Model For Page Layouts”, filed Sep. 18, 2019, which is incorporated by reference herein in its entirety.

### BACKGROUND

Webpage publishing generally allows pages of a publication to be laid out using an entirely freeform approach or, alternately, to lay out pages automatically using static templates. For example, a website for a business may be professionally designed using templates to provide a consistent theme, including without limitation, the color, size, placement and styles of titles, controls, text, etc. Typically, such themes are propagated throughout the website within some limited variation to maintain a sense of unity within the website. However, the content of such websites can change, for example, as the communication needs of the business change, such as during different shopping seasons, different holidays, different sales events, etc. An example is the addition of a press release on a new product—the business will typically want to post the press release on the website of the business. The user typically inputs the press release content into a website via a content management system (CMS), which combines the new content with page templates and/or page layout templates to create a new consistently designed webpage containing the new content for the website.

Thus, existing publishing applications generally allow pages of a publication to be laid out using an entirely freeform approach or, alternately, to lay out pages automatically using static templates. Applications using the freeform approach provide little if any design guidance. These types of applications thereby allow skilled users the flexibility to create virtually any type of page layout for their publication. For instance, a publishing application using the freeform approach requires a user to design and place all of the content on each page of a publication, and to manually break content to change the flow of the content on and between pages. While these types of applications are suitable for highly skilled designers, this approach to publishing is generally unsuitable for users that do not have the creativity or design skills to create their own layout, and it is often desirable to limit the amount of changes such novice user can make.

Additionally, existing publication applications and approaches often have issues with building content that is sharable across pages. There is also limits in the lifecycle of shared content where content would be locked even if the content is not in the state of being edited (e.g., during localization). Existing publication applications and approaches also do not have templates to provide a uniform look for a group of pages. Changes to the pages typically have to be performed using customized coding.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one more examples, a computerized method for generating content defines a master template using a data model and receives user inputs used to generate a template from the master template. A page instance is generated from the template and a page fragment generated from the template. The data model is configured to allow building of the template using a plurality of modules, wherein the data model defines customizable limits to the content modifications allowed to the template, including displaying only a subset of the plurality of modules that are modifiable by the template. The computerized method further generates a displayable page based on the template.

Many of the attendant features will be more readily appreciated as the same becomes better understood by reference to the following detailed description considered in connection with the accompanying drawings.

### BRIEF DESCRIPTION OF THE DRAWINGS

The present description will be better understood from the following detailed description read in light of the accompanying drawings, wherein:

FIG. 1 illustrates master template generation according to an implementation;

FIG. 2 illustrates page elements according to an implementation;

FIG. 3 illustrates an identity pattern according to an implementation;

FIG. 4 illustrates a layout for a master template according to an implementation;

FIG. 5 illustrates a layout for a generic template according to an implementation;

FIG. 6 illustrates a layout for a storytelling template according to an implementation;

FIG. 7 illustrates a generic PDP setup according to an implementation;

FIG. 8 illustrates a storytelling PDP setup according to an implementation;

FIG. 9 illustrates an overall data model architecture according to an implementation;

FIG. 10 illustrates a format for a page variation according to an implementation;

FIG. 11 is an exemplary schematic block diagram of a data processing system according to an implementation;

FIG. 12 illustrates a computing apparatus according to an implementation as a functional block diagram;

FIG. 13 is a screenshot of a template editor according to an implementation; and

FIG. 14 is a flowchart of a process for content management and generating content according to an implementation.

Corresponding reference characters indicate corresponding parts throughout the drawings. In the figures, the systems are illustrated as schematic drawings. The drawings may not be to scale.

### DETAILED DESCRIPTION

The computing devices and methods described herein in various examples are configured to use a data model representing pages, sharable fragments, assets, custom types, and/or locale fallback to control the design of published content (e.g., webpages). For example, content authors using the present disclosure can develop pages, custom types, shared fragments and assets, as well as localize all of these items. The present disclosure provides a robust data model to support one or more of the following: (1) flexible, interchangeable page layouts with reduced overhead, (2) sharing of assets, modules and partial pages as a core supported principal, (3) elements having a life cycle independent of the page, (4) rules that can be selected from a set of compatible layouts, (5) improved support for dynamic pages, and (6) unifying the approach to localization.

Various examples provide templating and the ability to swap a template for a page and the page automatically identifies or detects the changes. Additionally, some examples provide the ability to edit shared content in the content's own lifecycle independent of pages or other content that consume the shared content. Rules are also provided that define the content that can be seen on a page. With the present disclosure, content design and development is more easily controlled. As a result, processing time and processing resources are reduced. In this manner, when a processor is programmed to perform the operations described herein, the processor is used in an unconventional way, and allows, for example, for the more efficient generation of different content.

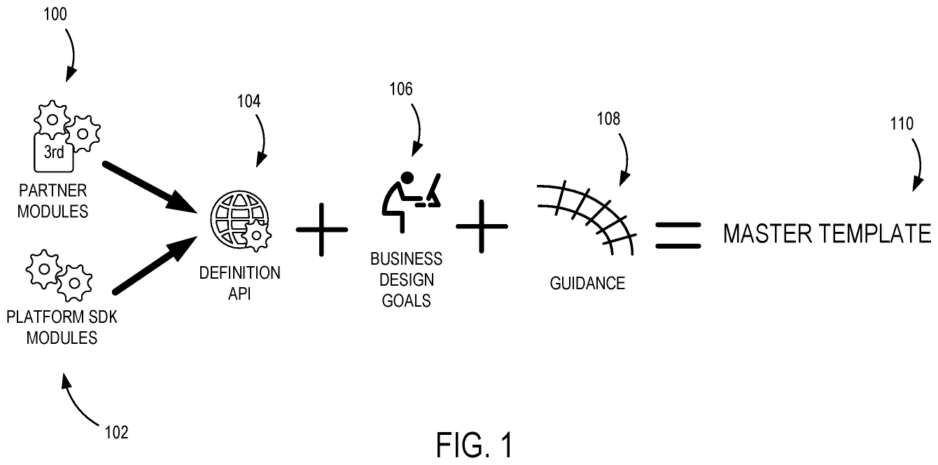

FIG. 1 illustrates the generation of a master template 110 according to one example. In this example, platform modules 102 (e.g., platform software development kit (SDK) modules) and/or third-party modules 100 inform a definition application programming interface (API) 104 of the features and limitations of the platform modules 102 and the third-party modules 100. That is, features and limitations are determined from the modules 100 and 102. Given all of the possible combinations of modules, an informed user decides which ones can be used, such as to meet business design goals 106. For example, user inputs are received in some examples to select features and limitations. It should be appreciated that in other examples, the selection can be semi-automated or automated, such as based particular criteria. The decisions are recorded as guidance 108 for less technical users to follow when creating pages. For example, a file or text is generated that is viewable. In this way, master templates are generated and establish the skeletal structure of the page and which modules can be used by content development application, for example, by a page author using the content development application. It should be noted that the guidance can range from loose to locked, depending on business needs.

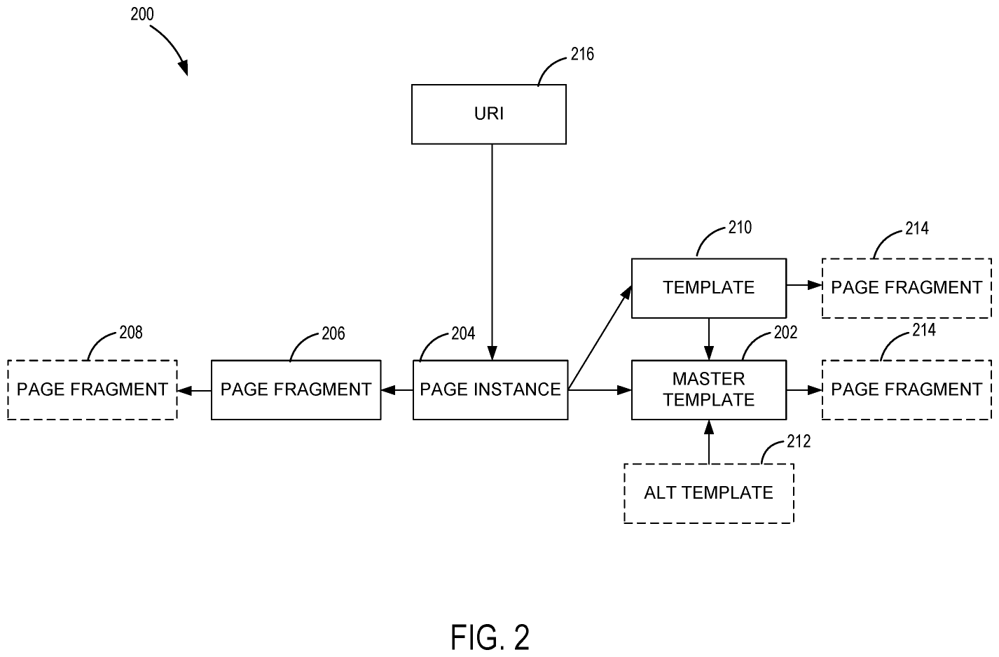

FIG. 2 illustrates the page elements 200 of the data model, such as the data model representing pages, sharable fragments, assets, custom types, and/or locale fallback to control the design of published content (e.g., webpages). In the illustrated example, the master template 202 is the starting point, which defines a base template, but the processes assumes that a user desires or needs to make some decisions based on the options allowed in the master template 202. Following is a description of the operations performed in one example (wherein “Click” refers to a mouse click by a user, but can be any type of user input):

Click 1: Page Instance 204 appears—using the guidance from the master template 202, the user's choices are recorded in the Page Instance 204. In the simplest example with no sharing, the master template 202 and the Page Instance 204 are the only two documents needed. For example, after creating the page defined by the Page Instance 204, a user might like or desire to maintain some portion of the page and be able to re-use that portion.

Click 2: Page Fragment 206 appears—a Page Fragment 206 represents a portion of a page that can be linked to. An example of a Page Fragment 206 is a Banner reused across the site. It should be noted that fragments can be linked together.

Click 3: Optional Page Fragment 208 appears. If the content varies from page to page and a user only wants the structure to be consistent, the module choices made from the master template 202 can be broken out into a separate file to which one or more Page Instances 204 link. This is a template.

Click 4: Template 210 appears—because every Page Instance 204 is limited by (must adhere to) guidelines provided by the master template 202, different layout combinations can be provided in the form of alternate templates (Alt Template) 212.

Click 5: Alt Template 212 appears—a user can switch the layout choices for the page by adjusting the link to a new template. Any changes made to the template update all the pages automatically, as long as data guidelines are met. A user can also add Page Fragments 214 directly to the master template 202. It should be noted that the limitations and guidelines described herein are adjustable, such as based on the experience level of the user, the application, the operating environment, etc.

Click 6: Page Fragment 214 linked to master template 202 appears—if a user wants the fragment to appear regardless of which template is selected, the fragment can be added to the master template 202. If it is locked, any Page Instance 204 created with this master template 202 gets that fragment automatically (e.g., is updated automatically). The page is now mostly created. It should be appreciated that some details are not described, such as adding links to images, video, and shared content items. All of these details are children of the Page Instance 204 or Page Fragment 206 in this example.

Click 7: Uri 216 appears—pages are assigned a URL that allows a user to access the Page Instance 204. Without this, the Page Instance 204 is only accessible via internal tools.

It should be appreciated that the above-order of click operations is merely for example. That is, the order in which pages appears can be changed and can be selectively accessed as desired or needed in some examples.

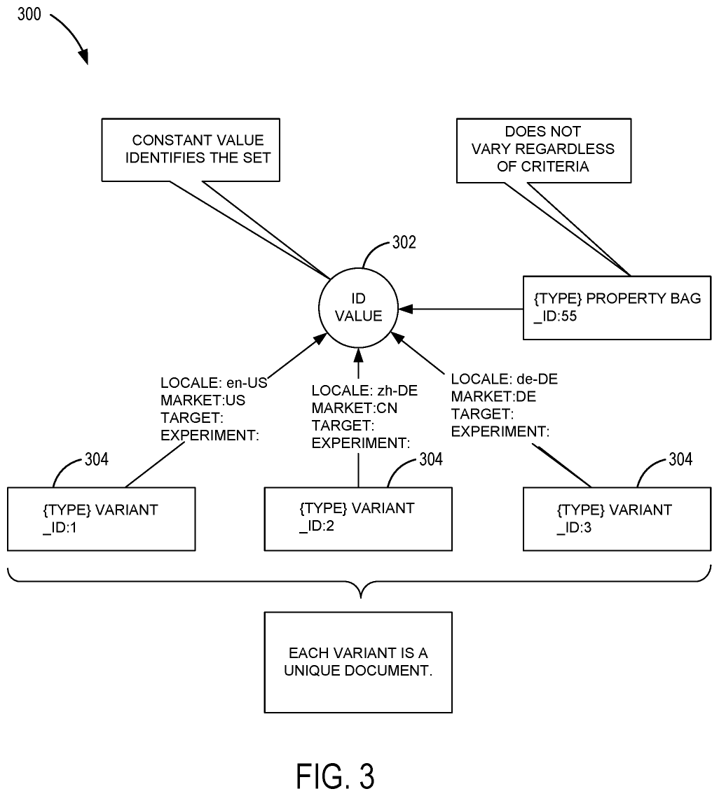

It should be noted that to create a different translated page for a different locale (e.g., country having a different language or local requirements) or a completely different page for market-specific reasons, an identity pattern 300 is used such as illustrated in FIG. 3. The identity pattern 300 groups documents that are part of a set. For example, an identification (ID) value 302 and variant criteria 304 form a multi-part key used to retrieve a variant document instead of the ID of the document, with associated properties returned automatically. That is, each of the variant criteria 304 defines a unique document with certain aspects or features of the document modified, such as based on how a user at a particular locale would expect to see content, local requirements, industry requirements, etc.

Additionally, the translated page (based on the variant criteria 304) can be created using the identity represented assets and process described in co-pending U.S. patent applications, both entitled Identity Represented Assets in a Content Management System, filed on Sep. 18, 2019 and Apr. 1, 2020, and having docket numbers 407436-US-PSP and 407436-US-NP. It should be noted that localization and marketization are two possible variations of a page. The two variations may have different content, but the variations have a common intent. The identity pattern is used to group the pages together as a set for workflow and resolution purposes in some examples.

It should be noted that various documents in some examples are linked by identity and can have variants. In one example, the documents include the Page Instance 204, Page Fragment 206, Optional Page Fragment 208, Page Fragment 214 and Uri 216. Each of these represents a set of one or more documents as follows:

For UriVariants, the URL for the home page can link to one Page Instance 204 for one Market/Channel, but can link to a completely different Page Instance 204 for a different Market/Channel.

Page Instances 204 can vary by market if the page content is fundamentally different. It should be noted that since the page content often contains embedded text strings, the content usually varies by locale.

Also, since the Page Fragments 206, 208, 214 are essentially mini-Page Instances 204, the fragments can vary by Market/Channel or locale.

Page Instances 204 and Page Fragments 206, 208, 214 link to some external content items, such as images, videos, or shared text content. There are potential variations by market and locale as should be appreciated.

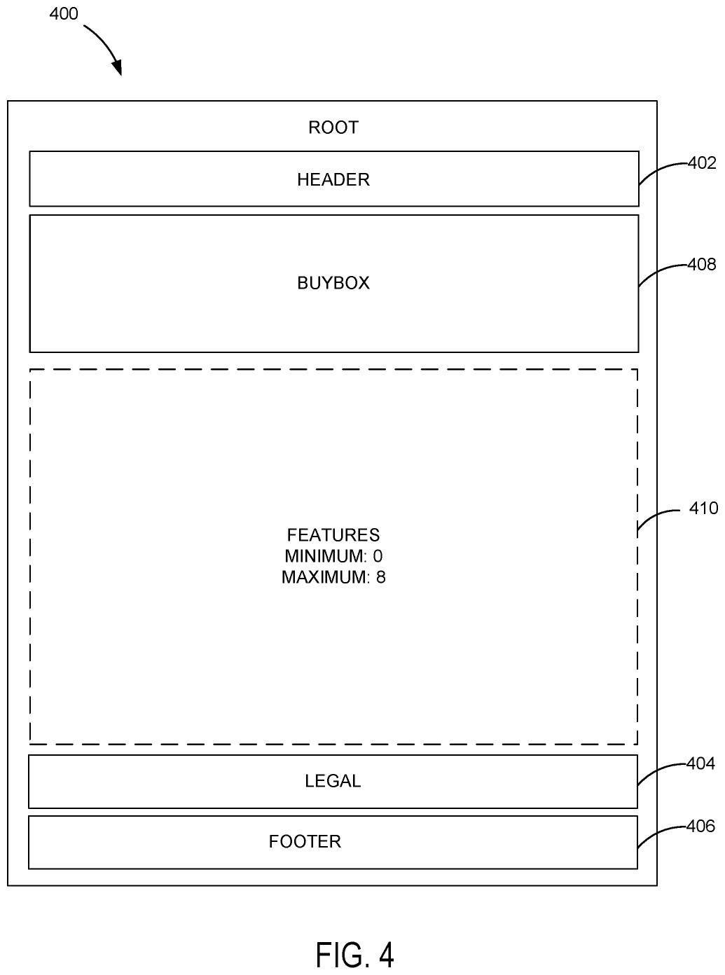

FIG. 4 illustrates a layout 400 for a master template, that can be embodied as the master template 202. The layout 400 in this example is defined as follows:

The Header 402, Legal 404, and Footer 406 portions are references to Page Fragments 206, 208, 214 to make the “look and feel” consistent. This content is locked in various examples to prevent users from changing the content. That is, this content is fixed.

The BuyBox 408 is also a Page Fragment 206, 208, 214 in this example. The content is unlocked so the content can be replaced downstream, but a default configuration is preset. The module is configured with a data provider that knows how to retrieve product details from a catalog source, when a product ID and channel/market reference is provided. That is, the data provider in some examples is a mechanism or module that allows for accessing this information.

An optional area 410 for storytelling allows for a defined number of Feature Modules (e.g., up to 8 Feature modules) to be included. If none are provided, this area will collapse. That is, modules that are user defined can be inserted and form part of the layout 400 (e.g., user defined content for this particular layout).

It should be noted that “Root” in the various examples refers to the root site or source site for the page or layout.

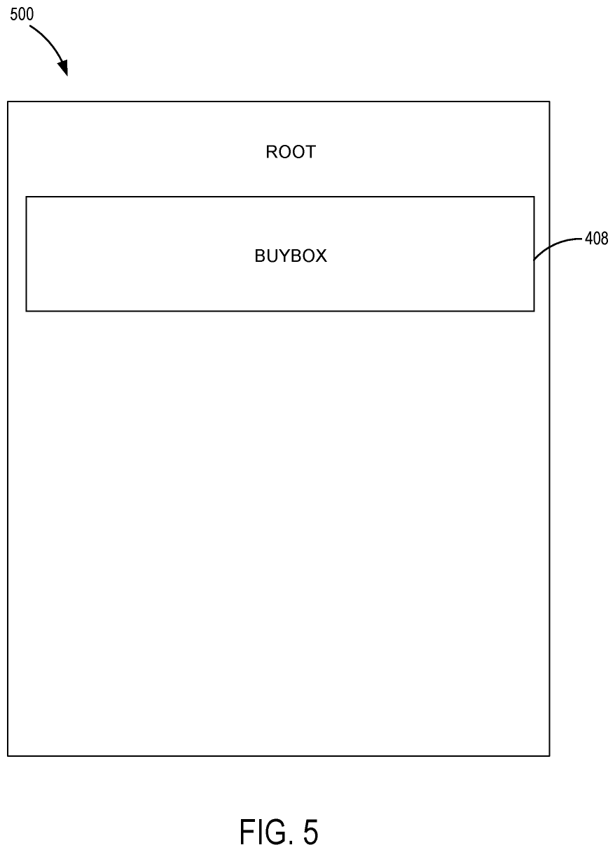

FIG. 5 illustrates a layout 500 for a generic template, which is defined in this example, as follows:

In this template created from the Master Template 202, because the header 402, footer 406, and legal 404 fragments are locked, these elements are not copied to this template. The source for these page elements are defined in the Master Template 202 and are injected (e.g., populated) into the final page automatically by the system.

Since the BuyBox 408 is unlocked with default data in this example, the version that was there can be kept or a fragment can be added. In this example, the fragment is overridden with the BuyBox 408.

It should be appreciated that because there is no storytelling, there is no data for a Feature. This Template defined by the layout 500 preserves that choice.

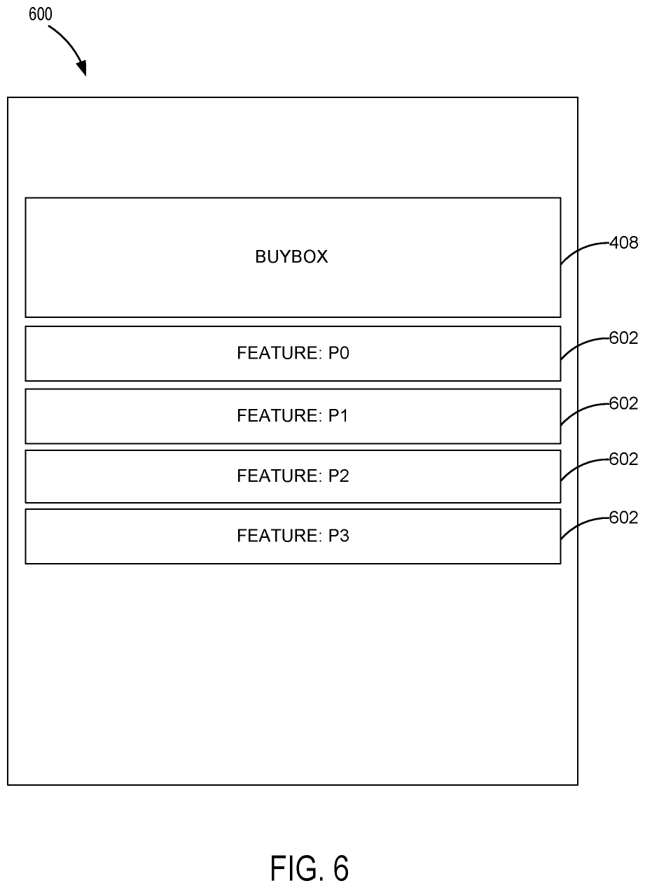

FIG. 6 illustrates a layout 600 for a sample storytelling template, which is defined is this example, as follows:

In this template created from the Master Template 202, because the header 402, footer 406, and legal 404 fragments are locked, these elements are not copied to this template. The source for these page elements are defined in the Master Template 202 and are injected (e.g., populated) into the final page automatically by the system.

The layout 600 overrode the default, and is done in this template as well, but it is not required.

This template is intended for “storytelling” and includes a plurality of feature slots 602 (four feature slots are shown). It should be noted that the order of the modules defining the feature slots 602 is significant, in that if the modules are re-ordered, the reordering affects any Page Instance 204 using this template

It should be noted that the data sources or fields of the Feature Modules are re-configured in some examples and locked if desired, or new defaults set for this template.

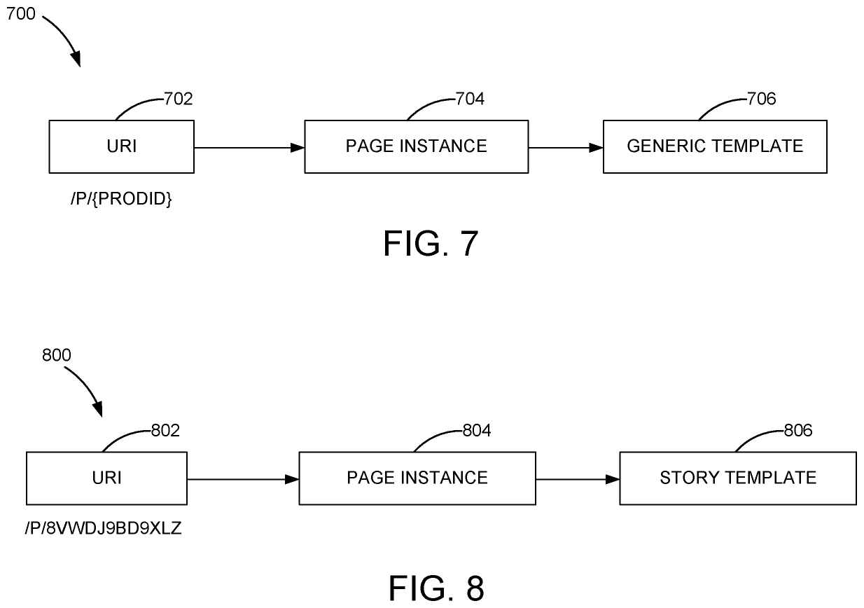

FIG. 7 illustrates a generic PDP setup 700, which in this example is defined, as follows:

Create a URI at 702 that uses a tokenized URI to handle the generic pages that have not been enriched yet (e.g., added to or populated).

Point the URI to a generic Page Instance 204 at 704 that is essentially empty, which links to the Generic Template at 706 that has locked Fragments with data providers that know what to do with the prodid parameter provided. That is, user defined or custom content can then be added as described herein.

A PDP (/p/{prodid}) is thereby available as soon as the PDP appears in the catalog. For example, a PDP file created, such that a generic page (webpage) can be generated in some examples, such as a generic product for sale webpage.

FIG. 8 illustrates a storytelling PDP setup 800, which in this example is defined, as follows:

Following the tokenized pattern, a new URI at 802 is created specifically for a product and pointed to a Page Instance 204 at 804 for that product.

This Page Instance 802 links to the Storytelling Template at 806 created earlier with slots for 1-4 features (e.g., feature slots 602) as described herein.

Input is then received, such as from a user (e.g., a web production person), to populate or fill in the slots provided and publishes the page (e.g., a more detailed product page).

It should be noted that when resolving the URIs, a search is performed for an exact match. If an exact match is not found, a fall back is provided to the tokenized form of the URL and the generic template is loaded.

Thus, in various examples, pages are defined as follows:

Each page consists of one or more page elements:

A Master Template;

A Template;

A Page Instance; and

0-n Fragments.

Each Page Element has a full life-cycle and,

can be created independently;

can be published;

can be deleted when no references to it remain; and

can contribute metadata to a page.

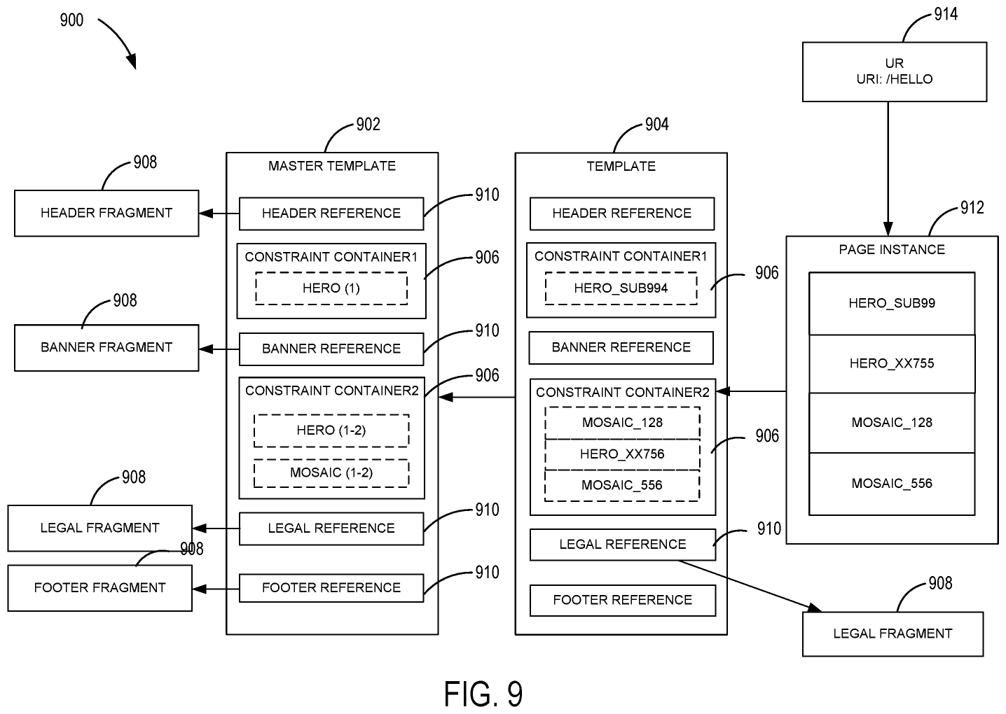

A specific example is illustrated in FIG. 9 illustrating a data model 900, illustrated as an overall data model architecture, wherein the various elements are defined in this example as:

1. A Master Template 902 that contains the structural guidelines common to a set of Templates 904 and provides constraints (using constraint containers 906) on the flexibility allowed in each Template):

Establishes the constraints that determine which modules are allowed by the Templates 904;

The Master Template 902 does not vary by locale or market. The Master Template 902 is referred to directly, not via an Identity; and

The Master Template 902 contains a default Template used as a starting point.

The Master Template 902 is not localizable.

The Master Template 902 can contain direct references 910 (e.g., legal reference, banner reference, header reference, etc.) to one or more Fragment IDs 908 (e.g., legal fragment, banner fragment, header fragment, etc.).

The Master Template 902 can indicate one or more modules that are allowed in the Templates that link to the Master Template 902. Each of these indicators include in various examples:

A reference to a module definition;

A “friendly” name for accessibility purposes;

A ConstraintId; and

A set of minOccurs and maxOccurs attributes that define how many of the modules are allowed.

It should be noted all modules available to an author of a Template must be explicitly listed in the Master Template 902. These modules can be designated as required or optional.

By default, Fragment references in the Master Template 902 are locked, meaning these references cannot be overridden by a Template or Page Instance 912 later.

The Master Template 902 can unlock a Fragment reference by adding locked=false to the fragment reference. An unlocked Fragment serves as default content that can be overridden later.

The Master Template 902 is not URL-addressable, for example, is not accessible by a URL 914 that access the Page Instance 912.

The Master Template 902 cannot contain rules.

The Master Template 902 can be part of a Master Template Family. For example, related Master Templates 902 can be linked.

Master Templates 902 that are part of the same family can be used interchangeably because the templates use a common set of module definitions and naming conventions.

The author of the Master Template 902 creates a Master Template Family by selecting “Create Master Template Family” while the Master Template is open, which can be a user selectable option in the interface.

To ensure backward compatibility, tools (e.g., webpage developer tools) do not allow users to remove any modules that are already in the Master Template 902. Instead enable/disable modules are supported to soft-delete the modules from the Master Template 902.

2. Template (a Template instantiates the Master Template 902, following the guidelines and constraints of the Master Template 902. For example, the Master Template 902 defines/limits or determines that a page can contain 1-5 modules and the modules may be of type X, Y, or Z in any combination. A Template contains user defined selections (e.g., the author's choices) from the available options. In the previous example, the user may choose two modules of type X and three modules of type Y:

A Template is a hierarchical listing of modules that adhere to the constraints of the Master Template 902;

Templates that share the same Master Template 902 are data-compatible and can be used interchangeably;

Templates may be shared or may be private;

Templates may link to shared Fragments 908;

Templates are directly referenced; and

Templates may indicate some optional elements for the Master Template 902 are locked. That is, the optional elements cannot be modified.

Templates are not localizable.

Templates can contain direct references to one or more Fragments IDs.

Templates can override a Fragment referenced in the Master Template 902 if the Master Template 902 has not locked the Fragment 908.

Templates may supply a Fragment reference for one or more optional modules listed by the Master Template 902 and lock the modules individually as desired.

Templates may supply all the module settings and the settings as read-only.

Templates can contain rules for targeting and experimentation.

A Template has a “friendly” name for accessibility purposes.

A Template may be marked as non-sharable.

Templates based on the same Master Template 902 are inherently compatible.

The constraints of the Master Template 902 are enforced only at Template authoring time. After a Template is created, if changes to constraints cause the Template to no longer be compliant, an error message is displayed to the Template author the next time the author attempts to check-in the Template.

3. Page Instance 912:

A flattened list of modules to be used with a Template;

Has a full life-cycle and can be localized; May stand-alone using an embedded Template for the layout or may link to an external Template;

Cannot introduce new modules that are not allowed by the Master Template 902; May include more modules than can be displayed by a Template, e.g. the Master Template 902 may allow 1-5 modules of type X, the Page Instance 912 may contain data for 5 modules, but the Template may choose to only use two of the modules; May link to shared External Content Items, but uses embedded content by default; and May link to shared Fragments.

Page Instances can be localized.

Page Instances are URL-addressable.

Page Instances may be empty, e.g. a PDP page with no storytelling.

Page Instances are always created in the context of the Master Template 902. These instances always include a reference to the corresponding parent Master Template.

Page Instances allow rules to be run to select between compatible modules or select alternate content.

Page Instance supports Page Metadata (Page Content document that has Title, Description, SEO Keyword, etc.).

Modules marked as read-only in the Template only provide data binding information in the Page Instance file.

Any modules defined by the Master Template 902 that are not present in the Page Instance are dropped at render time. This is not applicable for page fragments 908 referenced in the Master Template 902, which are included.

4. Fragment 908 (a fragment is a Page Instance 912 and Template representing a portion of a page):

A Fragment has a full life-cycle;

Like a mini-version of a page, the fragment 908 has its own Template and Page Instance to provide configuration detail;

May vary by locale;

Content is embedded by default;

May link to shared External Content Items;

May link to other fragments (e.g., to a depth of 6 fragments); and

Not required to match any constraints.

Fragments 908 can be localized.

Each Fragment 908 and related variations are backed by, for example, an AzureCMS identity.

Fragments 908 are not URL-addressable in some examples.

Fragments 908 may contain rules for targeting and experimentation.

Fragments 908 may be created directly in an interface (e.g., the tools editor).

Fragments 908 may be referenced by the Master Template 902, Template, Page Instance 912, or other Fragment 908.

Fragments 908 may be private or shared. A shared Fragment 908 is visible in the Fragment Picker authoring UX, allowing the shared Fragment 908 to be selected and used across multiple pages. A private fragment is in a draft state and is not read to be made available to other users.

5. External Content Items:

Are authored against the item's full persistence schema if intended to be shared and not be authored using authoring hints;

Can vary by locale; and

Are external only in the sense that the external content item is not embedded.

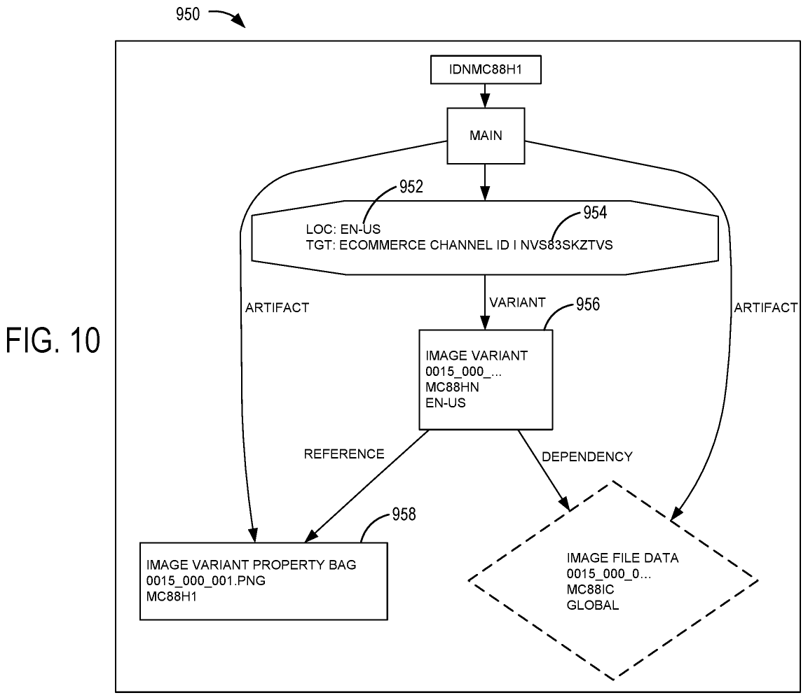

FIG. 10 illustrates a format 950 for a UriResolution with variations. In this example, the LocaleUriResolution disappears and a UriResolution document follows the identity pattern as described herein. In some examples, the image identity has one variation 952 with criteria locale:en-us and targeting 954: ecommercchannelid|nvs83skztvs. The image variant 956 (MC88Hn) has some alternate text strings and descriptions appropriate for en-US (US English locale) and designates the actual binary that is correct for this combination of criteria imageFileData MC88Ic. The imageVariantPropertyBag 958 stores all the properties that are consistent across all the variants. It should be noted that if there is another variant associated with this identity, another imageVariant, and imageFileData exists. There is only one imagevariantPropertyBag regardless of how many variations are created.

In operation with a CMS system, a user only references ID IDNMC88H1, and the system selects the correct variant based on criteria. If the required variant is not available, the system notifies the user, e.g. for the identity shown in FIG. 9, if the user asks for the es-ES version of the image, the system indicates to the user that the variant has not been localized for that locale yet.

Rules can run in some examples, as follows:

1. Experimentation/Marketization:

UriResolution; and

Template.

Targeting:

Page Instance;

Template; and

Fragment.

In various examples, each product is rendered based on one of the following:

A generic Template and a generic Page Instance for scenarios where there is no detail other than catalog information. This uses tokenized URL support; or

A specific Template and a URL-addressed Page Configuration for scenarios where storytelling modules have been created for the product.

In some examples, design principles for each module item in a flat list include:

Each item must be:

Indicated as authorable in the Master Template 902; and

A Container in the Master Template 902 that is marked with is Replaceable=true.

Each item will contain:

A module definition reference link; and

A ConstraintId.

The items are one of the following types:

Page Instance 912 with properties and data source configuration.

A reference to an external fragment identity.

Read-only fields defined in the Master Template 902 for Module Properties and External Data Source fields are enforced by the tools at authoring time.

In various examples, containers as used herein are a logical grouping of modules and some design principles or criteria include:

An empty container indicator in the Master Template 902 can only be replaced with a Fragment reference in the Page Instance 912.

A URL Resolution V3 (UR) maps a URL to a Template and the Page Instance 912 and some design principles or criteria include:

A UR may vary by locale, market, or other criteria. Variations are tracked using the AzureCMS Identity infrastructure.

A UR can contain rules to be used for targeting and experimentation.

Switching Templates for a given page are supported only through targeting rules inside an UR, wherein control through DCM is not supported.

Targeting and experimentation can be supported in page instance at four different granularity levels in some examples:

Content Item—a content item referenced by a module can be switched using targeting rules.

Individual Modules—Individual modules in the Page Instance 912 can be replaced by Module Variation that encompasses the various choices and rules.

Region/Container—Region level variation is supported only through page fragments 908.

Page—There are two variants in some examples:

Switching one page to another using targeting rules; and

Switching to a different Template for the same page using targeting rules.

Both variants are achieved by managing rules at an UR document. Tools ensure that Template switching is only allowed between compatible Templates. To be compatible, the Templates are either based on the same Master Template 902 or based on Master Templates 902 that are part of the same Master Template Family.

With reference again to FIG. 9 in this example, the Master Template 902 includes links to Header, Banner, Legal, and Footer Fragments 908, of which only the Legal fragment 908 is marked as unlocked. When the Template was created in this example, the legal reference was overridden with one that is more suited to the page. A hero is in the first position and a Mosaic-Hero-Mosaic pattern of modules in the second position. When, for example, a Web Producer begins to create the Hello page 914, the Template is selected as the starting point. In the authoring UX, the configuration for four modules is filled in. The Page Instance 912 is saved and checked in. The Page Instance 912 passes validation against the Master Template 902 constraints. The Template that was used to author the Page Instance 912 is saved within the Page Instance 912. The URL is assigned to the page, for example by the Web Producer, which adds Page Instance references to the UR. It should be noted that the URL is associated separately from the plurality of webpages, such as defined by Page Instances 912. That is, the URL is tracked as a separate entity

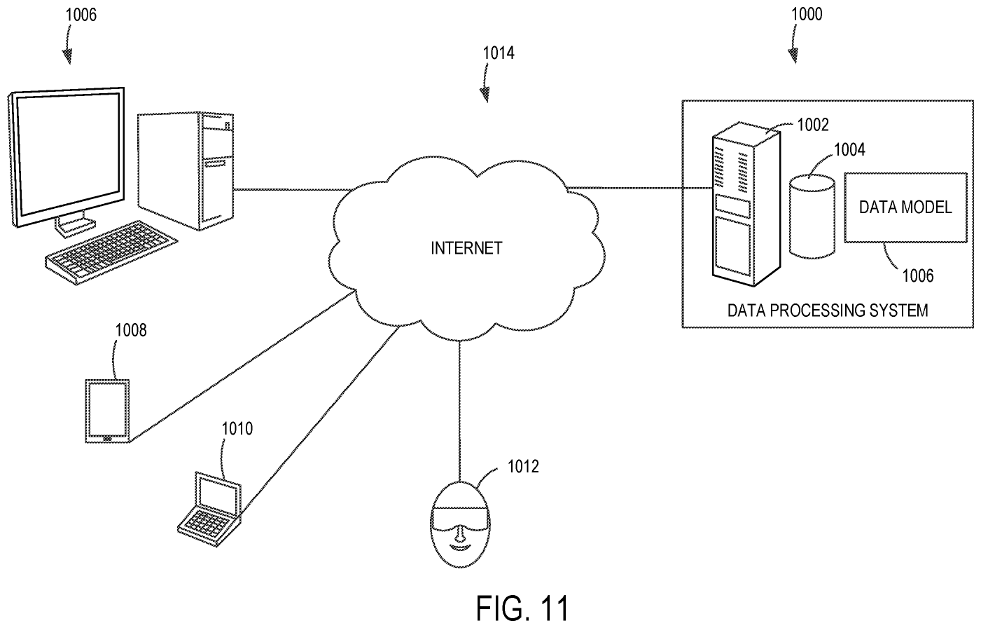

The various examples described herein can be implemented in a data processing system 1000 (e.g., a content management system (CMS)) deployed as a cloud service as illustrated in FIG. 11. In this example, the data processing system 1000 implements a data model 1006. The data processing system 1000 includes one or more computers 1002 and storage 1004 to store, for example, content for webpage design. It should be appreciated that other content can be stored in the storage 1004 and processed by the one or more computers 1002 using the present disclosure.

The data processing system 1000 is connected to one or more end user computing devices in some examples, such as a desktop computer 1006, a smart phone 1008, a laptop computer 1010 and an augmented reality head worn computer 1012 (e.g., Microsoft HoloLens®). For example, the data processing system 1000 is shown as connected to the end user computing devices via a computer network 1014, illustrated as the Internet.

The data processing system 1000 receives input data, such as design data from an end user computing device or server. The data is uploaded to the data processing system 1000 for processing sung the data model 1006. It should be appreciated that some or all of the data processing system 1000 or the functionality of the data processing system 1000 can be implemented within the end user computing device.

In some examples, the functionality of the data processing system 1000 described herein is performed, at least in part, by one or more hardware logic components. For example, and without limitation, illustrative types of hardware logic components that are used include Field-Programmable Gate Arrays (FPGAs), Application-specific Integrated Circuits (ASICs), Application-specific Standard Products (ASSPs), System-on-a-chip systems (SOCs), Complex Programmable Logic Devices (CPLDs), Graphics Processing Units (GPUs).

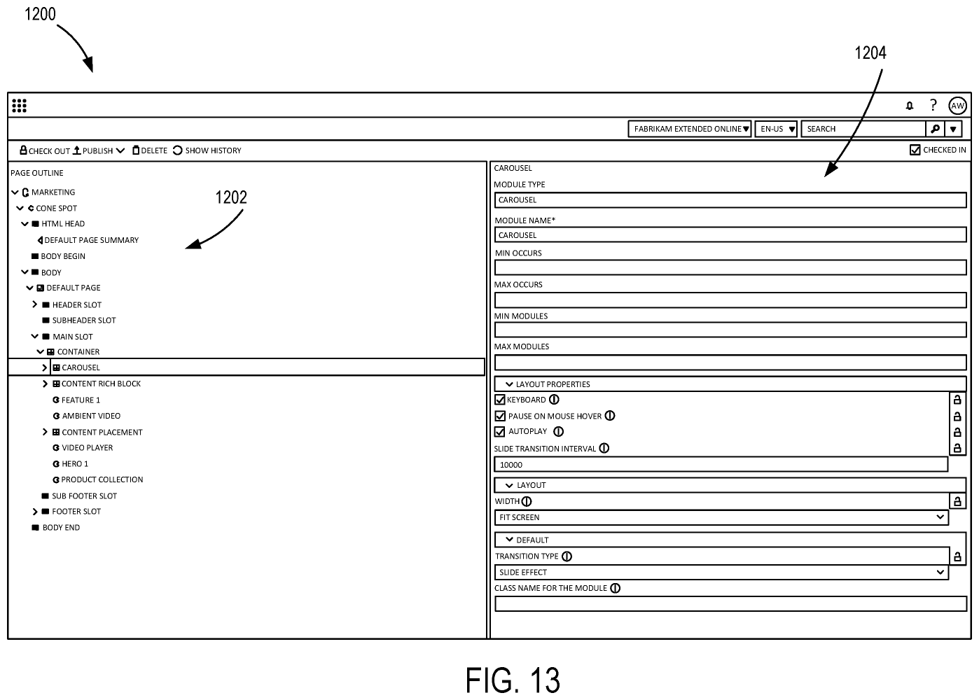

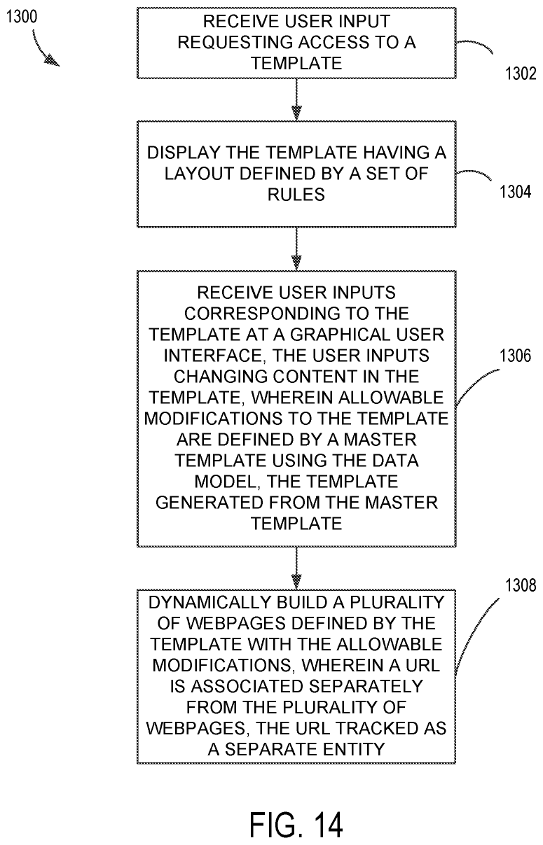

FIG. 13 is an example of a template editor 1200 (e.g., a graphical user interface) showing a skeletal structure 1202 of a page. In this example, the constraints are set using fields 1204 allowing a Carousel module to be authored. Some of the layout properties are set by default such that the downstream user cannot change this content. It should be noted that the carousel module is used to put multiple promotional items (including rich images) in a rotating carousel banner that users (e.g., customers) can browse. For example, a retailer can use a carousel module on a home page to showcase multiple new products or promotions. Thus, a Page Instance can be created from the template using the template editor 1200, wherein a carousel module is added because such addition was allowed by the template.

The above is merely an example and the template editor 1200 can be used to create different content. For example, a Header Fragment can be created and used across many pages. This fragment can be set in the template, such that any creation of a new page from the template automatically has the header fragment inserted.

In some examples, different layouts are provided. In one particular example, the options allowed by a Template are defined such as by the pattern that is expected to be used a number of pages that are expected to always look consistent. If the pages all share the same layout, changes can be made to the one layout and the changes are reflected across all the pages that use that layout.

FIG. 13 is a flowchart 1300 illustrating operations involved in content management and generating content. In some examples, the operations described for flowchart 1300 are performed by the data processing system 1000 of FIG. 10 or the computing apparatus 1100 of FIG. 11. With the flowchart 1100, content for webpages can be generated, for example, using a data model as described herein.

More particularly, the flowchart 1300 commences at operation 1302 with receiving a user input requesting access to a template. For example, modification to webpage content may be desired.

At operation 1304, the template is displayed having a layout defined by a set of rules. For example, as described herein, some content in modifiable and other content is not modifiable as defined by the rules. At operation 1306 user inputs corresponding to the template are received at a graphical user interface, the user inputs changing content in the template, wherein allowable modifications to the template are defined by a master template using the data model, the template generated from the master template. That is, a described herein a multi-step of multi-click process is defined that allows for modification to the template. In this way, no specialized code or XML interface is needed to modify the template.

At operation 1308, a plurality of webpages are dynamically built or generated as defined by the template with the allowable modifications, wherein a URL is associated separately from the plurality of webpages, the URL tracked as a separate entity. That is, the webpages are easily generated across a plurality of platforms based on the modified template.

Thus, webpages are generated based on a master template that is modifiable based on the limits defined by the data model. For example, a master template allows a subset of modules to be on a page that results in workflow optimizations. With the present disclosure, webpages and templates can be built without code to define particular aspects for the different webpages and templates.

### Exemplary Operating Environment

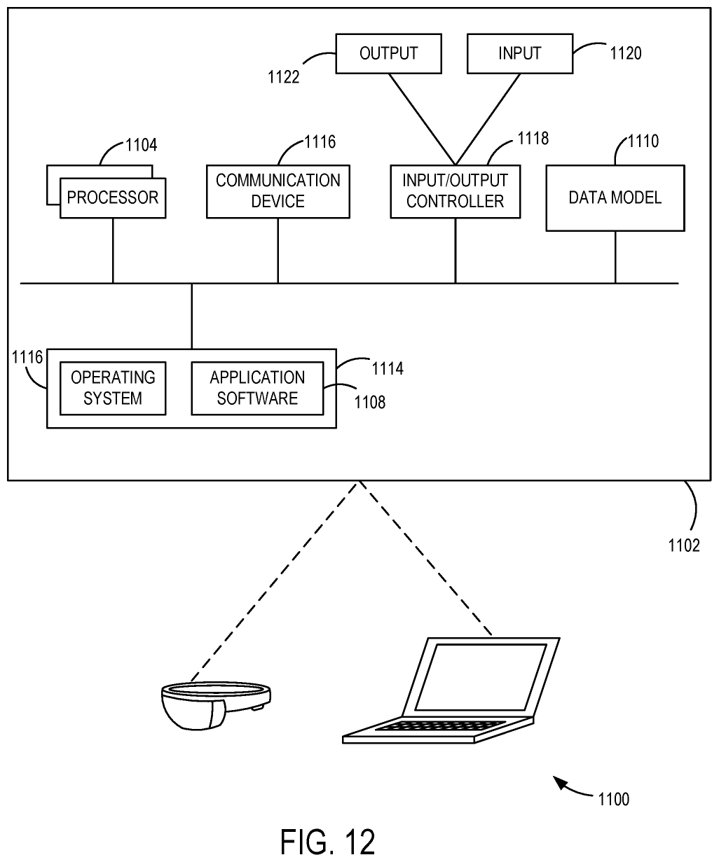

The present disclosure is operable with a computing apparatus 1102 according to an embodiment as a functional block diagram 1100 in FIG. 12. In one example, components of the computing apparatus 1102 may be implemented as a part of an electronic device according to one or more embodiments described in this specification. The computing apparatus 1102 comprises one or more processors 1104 which may be microprocessors, controllers or any other suitable type of processors for processing computer executable instructions to control the operation of the electronic device. Platform software comprising an operating system 1106 or any other suitable platform software may be provided on the apparatus 1102 to enable application software 1108 to be executed on the device. According to an embodiment, content design using a data model 1110 can be accomplished by software.

Computer executable instructions may be provided using any computer-readable media that are accessible by the computing apparatus 1102. Computer-readable media may include, for example, computer storage media such as a memory 1114 and communications media. Computer storage media, such as the memory 1114, include volatile and non-volatile, removable and non-removable media implemented in any method or technology for storage of information such as computer readable instructions, data structures, program modules or the like. Computer storage media include, but are not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media do not include communication media. Therefore, a computer storage medium should not be interpreted to be a propagating signal per se. Propagated signals per se are not examples of computer storage media. Although the computer storage medium (the memory 1114) is shown within the computing apparatus 1102, it will be appreciated by a person skilled in the art, that the storage may be distributed or located remotely and accessed via a network or other communication link (e.g. using a communication interface 1116).

The computing apparatus 1102 may comprise an input/output controller 1118 configured to output information to one or more input devices 1120 and output devices 1122, for example a display or a speaker, which may be separate from or integral to the electronic device. The input/output controller 1118 may also be configured to receive and process an input from the one or more input devices 1120, for example, a keyboard, a microphone or a touchpad. In one embodiment, the output device 1122 may also act as the input device 1120. An example of such a device may be a touch sensitive display. The input/output controller 1118 may also output data to devices other than the output device 1122, e.g. a locally connected printing device. In some embodiments, a user may provide input to the input device(s) 1120 and/or receive output from the output device(s) 1122.

In some examples, the computing apparatus 1102 detects voice input, user gestures or other user actions and provides a natural user interface (NUI). This user input may be used to author electronic ink, view content, select ink controls, play videos with electronic ink overlays and for other purposes. The input/output controller 1118 outputs data to devices other than a display device in some examples, e.g. a locally connected printing device.

The functionality described herein can be performed, at least in part, by one or more hardware logic components. According to an embodiment, the computing apparatus 1102 is configured by the program code when executed by the processor(s) 1104 to execute the embodiments of the operations and functionality described. Alternatively, or in addition, the functionality described herein can be performed, at least in part, by one or more hardware logic components. For example, and without limitation, illustrative types of hardware logic components that can be used include FPGAs, ASICs, ASSPs, SOCs, CPLDs, and GPUs.

At least a portion of the functionality of the various elements in the figures may be performed by other elements in the figures, or an entity (e.g., processor, web service, server, application program, computing device, etc.) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that may be suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein.

In examples involving a general-purpose computer, aspects of the disclosure transform the general-purpose computer into a special-purpose computing device when configured to execute the instructions described herein.

Other examples include:

A system for content management, the system comprising:
at least one processor;
storage storing a data model representing content; and
at least one memory comprising computer program code, the at least one memory and the computer program code configured to, with the at least one processor, cause the at least one processor to:
receive a user input requesting access to a template;
display the template having a layout defined by a set of rules;
receive user inputs corresponding to the template at a graphical user interface, the user inputs changing content in the template, wherein allowable modifications to the template are defined by a master template using the data model, the template generated from the master template; and
dynamically build a plurality of webpages defined by the template with the allowable modifications, wherein a URL is associated separately from the plurality of webpages, the URL tracked as a separate entity.

A computerized method for generating content, the computerized method comprising:
defining a master template using a data model;
receiving user inputs used to generate a template from the master template, wherein:
a page instance is generated from the template, and
a page fragment generated from the template,
wherein the data model is configured to allow building of the template using a plurality of modules, the data model defining customizable limits to the content modifications allowed to the template, including displaying only a subset of the plurality of modules that are modifiable by the template; and
generating a displayable page based on the template.

One or more computer storage media having computer-executable instructions for image processing that, upon execution by a processor, cause the processor to at least:
receive a user input requesting access to a template;
display the template having a layout defined by a set of rules;
receive user inputs corresponding to the template at a graphical user interface, the user inputs changing content in the template, wherein allowable modifications to the template are defined by a master template using the data model, the template generated from the master template; and
dynamically build a plurality of webpages defined by the template with the allowable modifications, wherein a URL is associated separately from the plurality of webpages, the URL tracked as a separate entity.

Alternatively, or in addition to the other examples described herein, examples include any combination of the following:

wherein the master template comprises fixed elements defining template portions that are references to page fragments, wherein one or more of the page fragments are modifiable, and further comprising one or more user defined modules;

wherein the content comprises at least one of pages, sharable fragments, assets, custom types, and locale fallback;

wherein the master template is configured to define a page instance, a page fragment representing a portion of the page instance that can be linked to, and the page fragment linked to the master template and included in all of the plurality of templates;

wherein the master template defines limitations on modifications to the template, and the plurality of webpages are defined by page instances that link to a portions of the content, the limitations being adjustable;

dynamically build the plurality of webpages without use of specialized code;

wherein the data model is configured to allow interchangeable page layouts including a sharing of assets, modules and partial pages, and wherein page elements have a life cycle independent of the page;

wherein the allowable modifications to the template are defined by a master template using the data model that includes selectable rules, wherein the selectable rules are selected from a set of compatible layouts;

swapping a template for the displayable page, including automatically identifying changes to the template;

wherein the master template comprises fixed elements defining template portions that are references to the page fragment, wherein the page fragments is modifiable, and the plurality of modules are user defined;

wherein the page fragment represents a portion of the page instance that can be linked to, and the page fragment is linked to the master template and included in any template;

wherein the master template defines limitations on modifications to the template, and the displayable page is defined by the page instance that links to a portion of desired content, the limitations being adjustable;

dynamically building a plurality of webpages corresponding to the displayable page without use of specialized code;

wherein the data model is configured to allow interchangeable page layouts including a sharing of assets, modules and partial pages, and wherein page elements have a life cycle independent of the displayable page;

wherein allowable content modifications to the template are defined by a master template using the data model that includes selectable rules, wherein the selectable rules are selected from a set of compatible layouts;

a master template that allows only a subset of modules to be on a page;

building a template without code;

building a webpage without code;

custom “guardrails” to limit the modifications to the template;

generic webpage construction using templates generated from a master template;

providing consistency across a plurality of webpages, including modifications thereto, using the “guardrails”;

selectable and being able to build customizable “guardrails”;

a graphical user interface with simplified controls for template generation;

creating a page instance that binds to a catalog while leaving a portion of the page available for other content;

migrating content from one problem space to another problem space;

creating templates without an XML interface;

model that handles pieces of documents to be handled consistently across documents;

maintaining the “look and feel” with content changing;

limiting modules as defined by the template author; and

a URL that is associated separately from the page and tracked as its own entity.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The embodiments illustrated and described herein as well as embodiments not specifically described herein but within the scope of aspects of the claims constitute exemplary means for training a neural network. The illustrated one or more processors 804 together with the computer program code stored in memory 814 constitute exemplary processing means for using and/or training neural networks.

The term “comprising” is used in this specification to mean including the feature(s) or act(s) followed thereafter, without excluding the presence of one or more additional features or acts.

In some examples, the operations illustrated in the figures may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for content management, the system comprising:
at least one processor;
storage storing a data model representing content; and
at least one memory comprising computer program code, the at least one memory and the computer program code configured to, with the at least one processor, cause the at least one processor to:
receive a user input requesting access to a template;
display the template having a layout defined by a set of rules;
receive user inputs corresponding to the template at a graphical user interface, the user inputs changing content in the template, wherein allowable modifications to the template are defined by a master template using the data model, the template generated from the master template; and
dynamically build a plurality of webpages defined by the template with the allowable modifications, wherein a URL is associated separately from the plurality of webpages, the URL tracked as a separate entity.

2. The system of claim 1, wherein the master template comprises fixed elements defining template portions that are references to page fragments, wherein one or more of the page fragments are modifiable, and further comprising one or more user defined modules.

3. The system of claim 1, wherein the content comprises at least one of pages, sharable fragments, assets, custom types, and locale fallback.

4. The system of claim 1, wherein the master template is configured to define a page instance, a page fragment representing a portion of the page instance that can be linked to, and the page fragment linked to the master template and included in all of the plurality of templates.

5. The system of claim 1, wherein the master template defines limitations on modifications to the template, and the plurality of webpages are defined by page instances that link to a portions of the content, the limitations being adjustable.

6. The system of claim 1, wherein the at least one memory and the computer program code are configured to, with the at least one processor, cause the at least one processor to dynamically build the plurality of webpages without use of specialized code.

7. The system of claim 1, wherein the data model is configured to allow interchangeable page layouts including a sharing of assets, modules and partial pages, and wherein page elements have a life cycle independent of the page.

8. The system of claim 1, wherein the allowable modifications to the template are defined by a master template using the data model that includes selectable rules, wherein the selectable rules are selected from a set of compatible layouts.

9. A computerized method for generating content, the computerized method comprising:
defining a master template using a data model;
receiving user inputs used to generate a template from the master template, wherein:
a page instance is generated from the template, and
a page fragment generated from the template,
wherein the data model is configured to allow building of the template using a plurality of modules, the data model defining customizable limits to the content modifications allowed to the template, including displaying only a subset of the plurality of modules that are modifiable by the template; and
generating a displayable page based on the template.

10. The computerized method of claim 9, further comprising swapping a template for the displayable page, including automatically identifying changes to the template.

11. The computerized method of claim 9, further comprising dynamically generating a plurality of webpages defined by the template, wherein a URL is associated separately from the plurality of webpages, the URL tracked as a separate entity.

12. The computerized method of claim 9, wherein the master template comprises fixed elements defining template portions that are references to the page fragment, wherein the page fragments is modifiable, and the plurality of modules are user defined.

13. The computerized method of claim 9, wherein the page fragment represents a portion of the page instance that can be linked to, and the page fragment is linked to the master template and included in any template.

14. The computerized method of claim 9, wherein the master template defines limitations on modifications to the template, and the displayable page is defined by the page instance that links to a portion of desired content, the limitations being adjustable.

15. The computerized method of claim 9, further comprising dynamically building a plurality of webpages corresponding to the displayable page without use of specialized code.

16. The computerized method of claim 9, wherein the data model is configured to allow interchangeable page layouts including a sharing of assets, modules and partial pages, and wherein page elements have a life cycle independent of the displayable page.

17. The computerized method of claim 9, wherein allowable content modifications to the template are defined by a master template using the data model that includes selectable rules, wherein the selectable rules are selected from a set of compatible layouts.

18. One or more computer storage media having computer-executable instructions for image processing that, upon execution by a processor, cause the processor to at least:
receive a user input requesting access to a template;
display the template having a layout defined by a set of rules;
receive user inputs corresponding to the template at a graphical user interface, the user inputs changing content in the template, wherein allowable modifications to the template are defined by a master template using the data model, the template generated from the master template; and
dynamically build a plurality of webpages defined by the template with the allowable modifications, wherein a URL is associated separately from the plurality of webpages, the URL tracked as a separate entity.

19. The one or more computer storage media of claim 18, wherein the master template defines limitations on modifications to the template, and the plurality of webpages are defined by page instances that link to a portions of the content, the limitations being adjustable.

20. The one or more computer storage media of claim 18, wherein the allowable modifications to the template are defined by a master template using the data model that includes selectable rules, wherein the selectable rules are selected from a set of compatible layouts.
